(19) United States
(12) Patent Application Publication
(10) Pub. No.: US 2009/0095776 A1
(43) Pub. Date: Apr. 16, 2009

(54) Wine preservation system and method

(76) Inventors: Peter Turner, Coral Gables, FL (US); Robert Turner, New York, NY (US); David Platt, New York, NY (US)

Correspondence Address: DOUGLAS C. WYATT;Wyatt, Gerber & O'Rourke, L.L.P, 99 Park Avenue,, New York, NY, 10016, US

(21) Appl. No.: 11/974,552

(22) Filed: Oct. 15, 2007

(51) Int. Cl. B67D 5/42

(52) U.S. Cl. 222/386.5

(57) ABSTRACT

An improved wine preservation and delivery system and method providing a container stopper, a replacement fluid and/or air pipe disposed through the container stopper, a flexible bladder for displacing wine as it is filled with fluid and/or air, and a fluid outlet pipe.

### BACKGROUND OF THE INVENTION

This invention is related to the art of wine preservation and delivery systems.

A problem commonly faced by individuals desiring to keep wine for long periods is the spoilage of wine that comes into contact with air and other reactive substances while it is being stored once opened. Such a problem can occur when an individual opens a container of wine and empties a portion of the container, such as to enjoy the wine, whereby air typically enters the container. Should an individual desire to store the wine after an initial use and reseal the container by conventional means, the remaining wine would be in contact with the air or subject to deterioration due to initial contact with air. Vacuum systems may remove air but do not stop the reaction begun when the bottle was poured. Inerting systems use gases, such as nitrogen or argon, to slow the oxidation process. Such systems are costly and require refill of gas. In addition, should an individual desire to empty additional wine, many conventional means of sealing the container, such as a stopper from a vacuum re-sealed bottle, must typically be removed, whereupon additional air enters the vessel. Gas inerting systems can avoid this problem by injecting inert gases and dispensing the wine through a tube at the bottom of the bottle, however such systems are expensive and require the replacement of the gas supply.

### SUMMARY OF THE INVENTION

The present invention provides a wine preservation and delivery system and method which addresses the afore-mentioned problems.

It is an object of the invention to provide an improved wine preservation and delivery system which can prolong the life of wine in a container that has been opened.

It is also an object of the invention to provide a wine preservation and delivery system which can be used to deliver wine in a container that has been opened without introducing additional air into the container in contact with the wine. It is a further object of the invention to avoid use of expensive gases, such as argon and nitrogen.

It is a further object of the invention to provide a wine preservation and delivery system which can be used to remove air that has been introduced into a container of wine after the container has been initially opened. It is a further object of the invention to replace the air in the container with a replacement volume of air or other substance that can fill a flexible bladder within the volume of the air replaced, without the replacement air coming into contact with the wine.

It is a further object of the invention to provide a flexible bladder and/or gas barrier which can be pressurized to permit the controlled delivery of any remaining wine in the container while preventing air from coming in contact with the wine.

It is a further object of the invention to provide a bladder pre-tensioning and inflection/deflation tube that can pre-tension and stretch the bladder along an inner-length of a container. It is a further object to provide a bladder pre-tensioning and inflation/deflation tube to avoid bladder breakage and promote effective expansion of the bladder.

Another object of the invention is to provide a void former to facilitate any remaining wine passing past inflated flexible bladder to exit the container through a fluid outlet pipe. Another object of the invention is to provide a wine preservation and delivery system which can be readily inserted into a container, and which can be adapted to containers of various shapes and sizes, and more particularly suited as a conical cork to fit various wine bottle openings, shapes and sizes.

A further object of the invention is to provide a wine preservation and delivery system which can preserve wine in a previously opened container, while safely permitting the dispensing of remaining wine in a controlled manner, and measured amounts over an extended period of time.

Accordingly, a wine preservation and delivery system is provided comprising a container stopper, having a bottom side and a top side and being formed to fit within an aperture of a container. In addition, a pressurization tube is provided, disposed through the container stopper, and a flexible bladder disposed over at least a portion of the pressurization tube. An outlet pipe is provided, disposed through the container stopper, and a void former is provided connected to the container stopper.

To facilitate the flow of fluid or other material past a flexible bladder in a container, the void former can comprise a tube having at least one aperture and can be disposed along a length of the flexible bladder. The void former can be attached to the pressurization tube at at least one end of the void former and can comprise a plurality of tubes, ribs, rings, and/or bumps disposed at least along a length of the void former.

In addition, a void former can include a float and/or a weight to provide a predetermined preferred orientation of the void former, which can be especially advantageous when the void former is provided as a tube. For example, a weight can be provided to orient a bottom end of the tube close to a bottom portion of a container, and a float can be provided to orient a top end of the tube close to a top portion of any fluid within the container.

### BRIEF DESCRIPTION OF THE DRAWINGS

Preferred embodiments of the inventive devices are illustrated in the drawings and are described below.

FIG. 1 illustrates a side view of a wine preservation and delivery system according to the present invention

FIG. 2 illustrates a cut-away cross section view of a portion of a wine preservation and delivery system according to the invention including a pressurization tube, a connection means and a flexible bladder.

FIG. 3 illustrates several alternative embodiments of a void former for use with a wine preservation and delivery system according to the present invention.

FIG. 4 illustrates a closeup and cutaway view of a portion of a wine preservation and delivery system according to the invention including a container stopper shown with a container opening.

FIG. 5 illustrates an alternative embodiment of a wine preservation and delivery system according to the present invention.

FIG. 6 illustrates a series of perspective views of a method of using wine preservation and delivery system according to the present invention.

FIG. 7 illustrates a series of perspective views of a method of using wine preservation and delivery system according to the present invention.

The above described figures may not be shown to scale, and are not intended to limit the scope of the description provided herein. Throughout the figures, the same reference numerals and characters, unless otherwise stated, are used to denote like features, elements, components or portions of the illustrated embodiments. Moreover, while the subject matter of the invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF THE INVENTION

A detailed description of a wine preservation and delivery system and method is provided below for general applicability. In addition, several specific embodiments are provided as examples of the devices which one of ordinary skill in the art may apply these teachings to address specific problems and to illustrate the benefits and improvements of the system over known solutions.

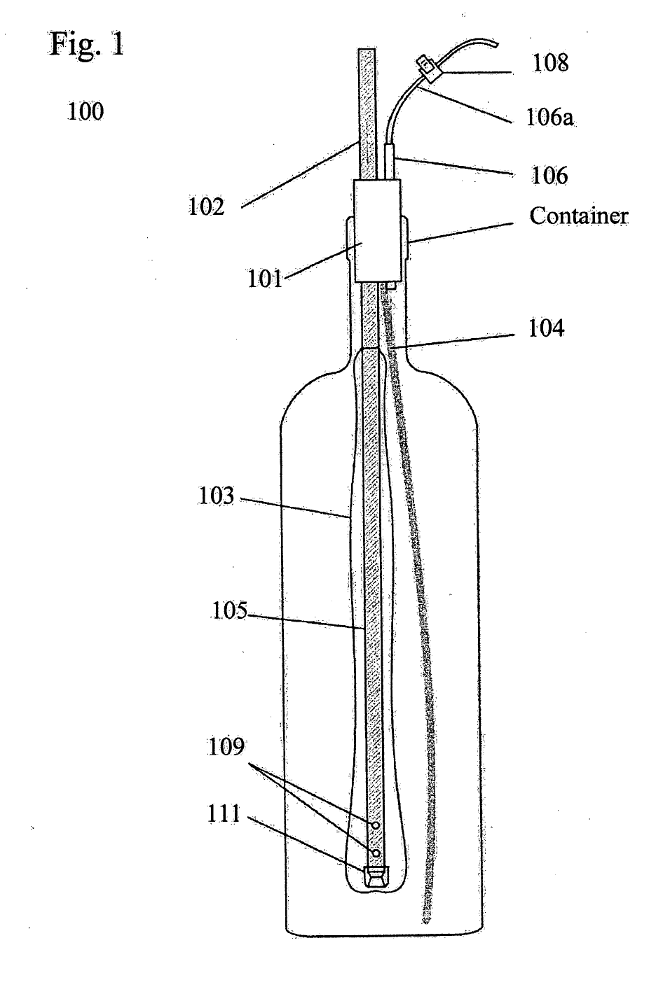

FIG. 1 shows a perspective side view of a wine preservation and delivery system 100 according to the invention. A wine preservation and delivery system 100 according to the invention includes a container stopper 101, a pressurization tube 102, a flexible bladder 103, and an outlet pipe 105. In one embodiment of the invention, a wine preservation and delivery system 100 can also be provided with a void former 104.

A container stopper 101 is provided which can provide a tight seal in an opening of a container, such as a cork, whereby fluids and gases are substantially prevented from entering or exiting the container through the contact areas of the container stopper 101 and the container. The container stopper 101 can also provide a base and attachment point of other parts of the system 100. The container stopper 101 can be fabricated from rubber, rubberized plastics, silicones, and other suitable materials for sealing containers. The container stopper 101 can be provided with one or more apertures which can extend from a top side of the container stopper 101 to a bottom side of the container stopper 101.

A pressurization tube 102 is provided through an aperture of the container stopper 101. A pressurization tube 102 according to the invention can be tube shaped and have an inlet and outlet. Thus, the pressurization tube 102 can function as a conduit through which liquid and/or gas, such as air, can pass and which can be pumped into a flexible bladder 103 in order to replace the volume of wine which may be dispensed from a container. The pressurization tube 102 includes a first opening disposed at the top side of the container stopper 101, and at least one second opening disposed at the bottom side of the container stopper 101. It can be appreciated that the openings of the pressurization tube 102 can extend beyond the surfaces of the container stopper 101. The pressurization tube 102 can be moveable within the container stopper 101 whereby a distal portion of the pressurization tube 102 can extend from the bottom side of the container stopper 101 at various lengths. Alternatively, the pressurization tube 102 can be provided with a variety of removable distal portions of distal lengths extending from the bottom side of the stopper to accommodate various sized containers. In another alternative embodiment, the pressurization tube 102 can incorporated into the stopper 101, such as by injection molding, and can be provided with an airtight seal such as by providing the pressurization tube 102 with a threaded connection. The pressurization tube 102 can be fabricated from either stiff or flexible materials sufficient for conducting the intended fluid and/or gas to be employed in the system 100.

A flexible bladder 103 is provided comprising a flexible container and an aperture, such as a balloon-like structure. Preferably, the flexible bladder is stretchable to conform to the inner surface of a container when inflated. All or part of the flexible bladder can comprise a gas barrier to prevent gases and any other reactive materials from coming into contact with the wine on the container. The flexible bladder 103 is disposed over at least a portion of the second opening of the pressurization tube 102, such as can be provided by inserting the distal end of the pressurization tube 102 through the aperture of the flexible bladder 103. Preferably, flexible bladder is disposed over the distal portion of the pressurization tube 102, and pre-tensioning tube or placement guide 105, if any, to guide the flexible bladder 103 into the container and to facilitate expansion of the flexible bladder 103 throughout the container 103.

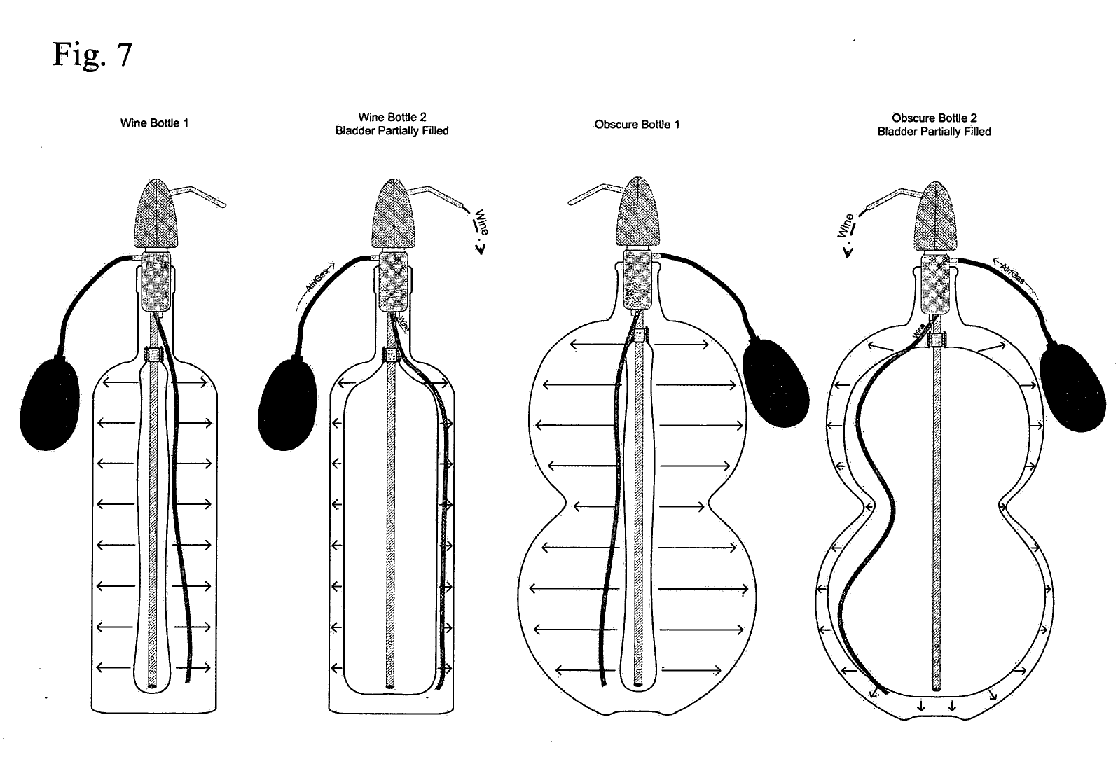

Accordingly, fluid and/or gas passing through the pressurization tube 102 can inflate or deflate the flexible bladder 103. The flexible bladder 103 is preferably fabricated from a flexible and stretchable material which can inflate and substantially fill the interior volume of the object container, including irregular shaped containers such as shown in FIG. 7. In addition, the flexible bladder 103 is preferably fabricated from a material that does not substantially interact with the material stored in the container.

It can be appreciated that the flexible bladder 103 can be fabricated in a variety of shapes in order to promote the bladder's functional ability to fill an interior volume of a container. Accordingly, in one embodiment of the invention, the flexible bladder 103 can be connected to the container stopper 101, or at a portion of the pressurization tube 102 proximate to the container stopper 101 in order to promote the flexible bladder 103 filling the volume of the container close to the container stopper 101.

The pressurization tube 102 can be provided with a placement guide 105 disposed at a distal portion of the pressurization tube 102. The placement guide 105 can be an extension of the pressurization tube 102, or it can be fabricated as a separate component and can comprise different material, such as a flexible tube. The placement guide 105 can function to guide the shape of the flexible bladder 103 thereby facilitating the insertion of the flexible bladder 103 into the container. In addition, or in the alternative, the placement guide 105 can be replacement with or provided with a pretensioning extension 109. A pretensioning extension 109 according to the invention can be provided for pretensioning the flexible bladder 103 in a non-deployed position. The pre-tensioning extension 109 can be used to avoid bladder breakage and promote effective expansion of the bladder 103. In addition, the pre-tensioning extension 109 can facilitate the expansion of the bladder 103 where surface friction and adhesion between the container's inner side-walls and the bladder may otherwise inhibit expansion of the bladder.

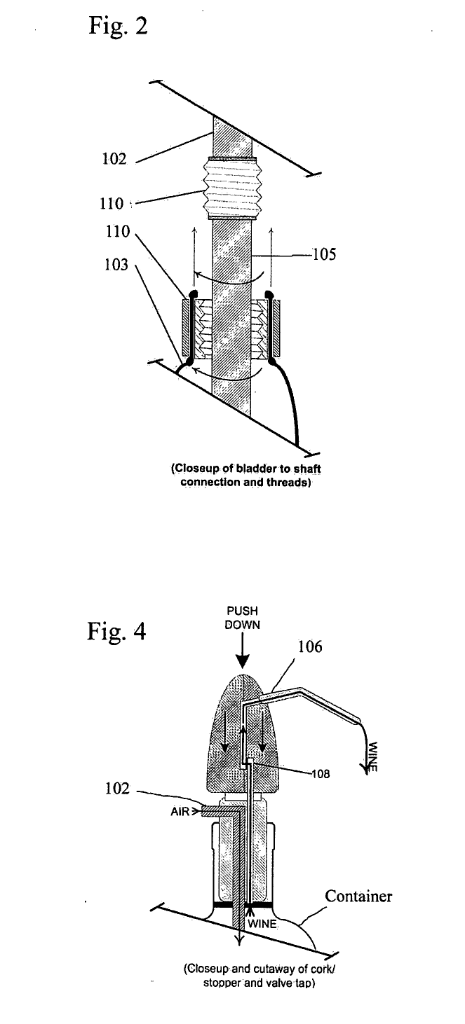

As shown in FIG. 2, the flexible bladder 103 can be connected to the pressurization tube 102 or the placement guide 105 by connection means 110. The connection means 110 according to the invention include a variety of means as can be appreciation by individuals of skill in the art to provide an air tight connection that allows for the easy replacement of the flexible bladder 103. One non-limiting example of a connection means 110 is a threaded screw connector that can be provided on the pressurization tube 102 or placement guide 105. A corresponding threaded screw connector can be provided at the opening of the flexible bladder 103.

In addition, the pressurization tube 102 can be provided with vents 109 through which fluid and/or gas can pass. In an embodiment in which a placement guide 105 is provided, the vents 109 can be provided in the placement guide 105.

The pressurization tube 102 can also be provided with a protection tip 110 at a distal portion of the pressurization tube 102. In an embodiment in which a placement guide 105 is provided, the protection tip 111 can be provided at a distal portion of the placement guide 105. The protection tip 111 can function to protect the flexible bladder 103 from being damaged or punctured by coming into contact with a distal portion of the pressurization tube 102, or placement guide 105, or inner portions of the container.

An outlet pipe 106 is provided through an aperture of the container stopper 101. The outlet pipe 106 can function as a conduit through which liquid and/or gas can pass, such as wine which can be dispensed out of a container, as well as any air trapped in the container. In an alternative embodiment, the outlet pipe 106 can be used as a conduit for inserting material into the container while the flexible bladder 103 is deflated. The outlet pipe 106 includes a first opening disposed at the top side of the container stopper 101, and at least one second opening disposed at the bottom side of the container stopper 101. It can be appreciated that the openings of the outlet pipe 106 can extend beyond the surfaces of the container stopper 101. For example, the second opening of the outlet pipe 106 can be within the aperture of the container stopper 101, or it can extend a variety of distances alongside the portion of the pressurization tube within the container and beyond. The outlet pipe 106 can be fabricated from either stiff or flexible materials sufficient for conducting the intended fluid and/or gas within the container. In addition, the outlet pipe 106 can be provided with a valve, such as a spring loaded air-sealed pressure valve or other air sealed valve, whereby wine can be dispensed at a controlled rate and closed to prevent the introduction of air.

In one embodiment of the invention, a distal portion of the outlet pipe 106 can be provided with a weighted portion to weight the outlet pipe toward the bottom of a container. In an alternative embodiment, the outlet pipe 106 can be provided with a floatation means for floating a portion of the outlet pipe proximate to the surface of fluid within the container. For example, an air filled cavity or a cork can be provided to float a portion of the outlet pipe 106, such as the second opening of the outlet pipe 106 near the top of the fluid to remove any remaining gas within the container. Preferably, the distal portion of the outlet pipe 106 is at least flush with the bottom surface of the container stopper 101.

In a further embodiment of the invention, at least one void former 104 is provided. The void former 104 can function to provide a space between the container and the flexible bladder 103 so that as the flexible bladder 103 expands, a space is provided at at least one portion of the interior volume of the container such that the contents of the container can pass from one portion, such as the bottom of the container, to the portion of the container having the outlet pipe. For example, the void former can facilitate wine being able to pass around the bladder, such as from the bottom of a bottle to the top, even though the flexible bladder may have expanded to fill the intervening portion of the container. The void former 104 can be a solid strand, a pipe, or molded rib, among other things and can be provided at a length to extend along the inner length of the container or the length of the bladder to facilitate fluid moving past the inflated bladder or deployed gas bladder as the fluid exits. The void forming strand allows for system equilibrium, an important aspect of fluid dynamics in the sealed system, and to ensure that fluids are not trapped in the bottle by the flexible bladder 102. It can be appreciated that the void former can be provided with the other components of the system 100 in a number of different configurations. For example, the void former 104 can be connected to the container stopper 101, or to the pressurization tube 102, or to the placement guide 105, or to the flexible bladder 103.

It can be appreciated that the void former 104 can be coupled with the outlet pipe 106 to facilitate the flow of fluid in and out of the container. However, in an application of the invention for use with wine bottles, it is preferable that the distal portion of the outlet pipe not be close to the bottom of the bottle to avoid the retrieval of any sediments which tend to collect at the bottom of wine bottles.

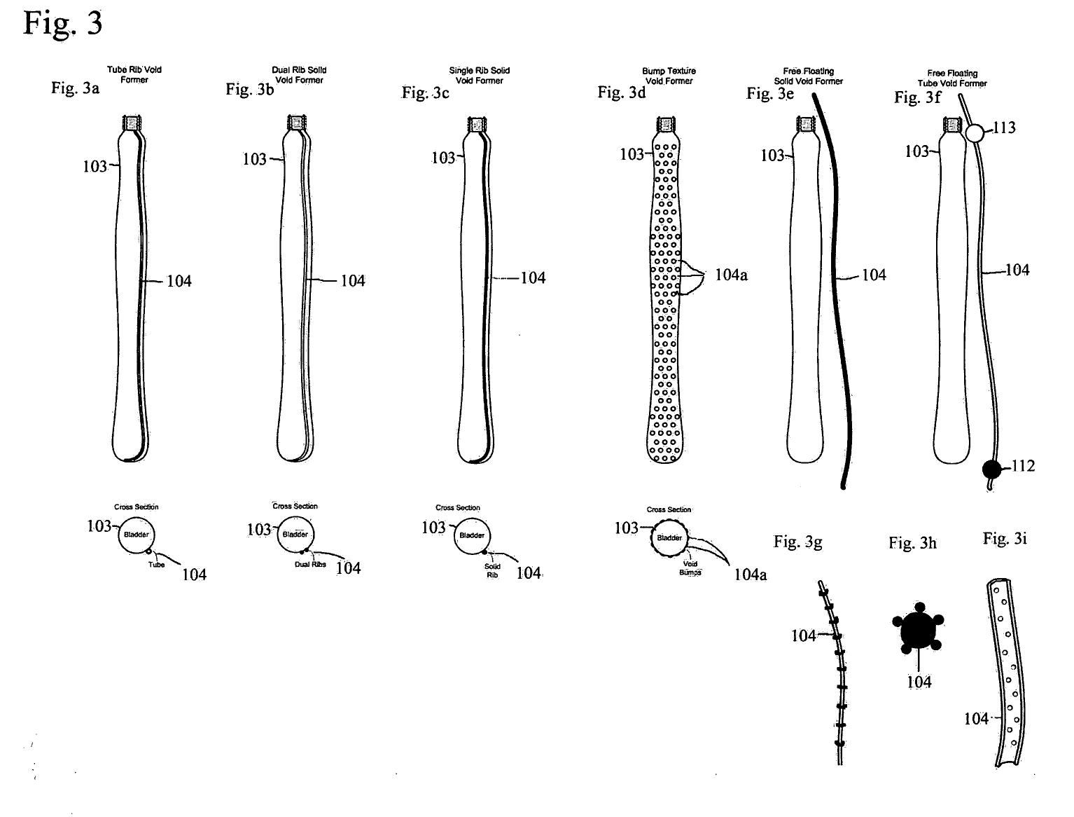

As shown in FIG. 3, it can be appreciated that it is possible to provide a number of different embodiments a void former 104 according to the present invention. The several embodiments of the void former 104 are not limited to those shown in FIG. 3 but also include variations and equivalents as can be appreciated by a person of ordinary skill in the art in view of the disclosed invention. For example, such as shown in FIG. 3a, a void former 104 can comprise one or more tubes, a portion of which can be disposed on the flexible bladder 103. In addition, a void former 104 can be formed as part of the flexible bladder 103. In FIG. 3i, a cut-away view of a portion of an alternative embodiment of a void former 104 is shown wherein the void former 104 comprises a tube portion having a plurality of apertures.

Alternatively, or in addition, the void former 104 can comprise one or more tubes which are free floating and disposed along a side of the flexible bladder 103, and alternatively can be operatively connected to other elements of the system 100, such as the stopper 101, as shown in FIG. 3f. In addition, or in the alternative, a void former 104 according to the invention can comprise one or more solid portions, as shown in FIG. 3b and FIG. 3c. A solid void former can be free floating and disposed along a side of the flexible bladder 103, and alternatively can be operatively connected to other elements of the system 100, such as the stopper 101, as shown in FIG. 3e.

In addition, or in the alternative, a void former 104 can comprise a tube or solid material having a plurality of ribs, rings and/or bumps. As shown in FIG. 3d, void forming features 104a, such as bumps, can be disposed on the flexible bladder 103, and thus further facilitates the flow of the contents of the container past the flexible bladder. As shown in FIG. 3g, showing a portion of a void former 104 from a side view, a void former 104 can be provided with one or more rings disposed on at least a portion of the void former 104. As shown in FIG. 3h, showing a cross section of a portion of a void former 104, a void former 104 can be provided with one or more bumps disposed on at least a portion of the void former 104. In addition, or in the alternative, the void former can comprise one or more ribs, each extending at least along a side of a portion of the void former 104.

In addition, or in the alternative, a void former 104 can be provided with one or more weights 112 and/or floats 113 disposed on a portion of the void former, as shown in FIG. 3f. Preferably, weights are provided on a bottom portion of the void former 104, and floats are provided on a top portion.

It can also be appreciated that a system 100 comprising one or more void formers 104, such as those shown in FIG. 3, is within the scope of the invention.

As shown in FIG. 4, a wine preservation and delivery system according to the invention can include a container stopper 101 including a portion incorporating an outlet pipe 106, and at least one control valve 108 for controlling the flow of fluid in the system 100. For example, a control valve can be provided at a portion of the outlet pipe 106. The control valve can be an airtight pressure and/or fluid release valve. It can be appreciated that control valves and pumps can be used with various embodiments of the invention to facilitate the removal or introduction of air into and/or out of the bladder, and or wine or other material into and/or out of the container.

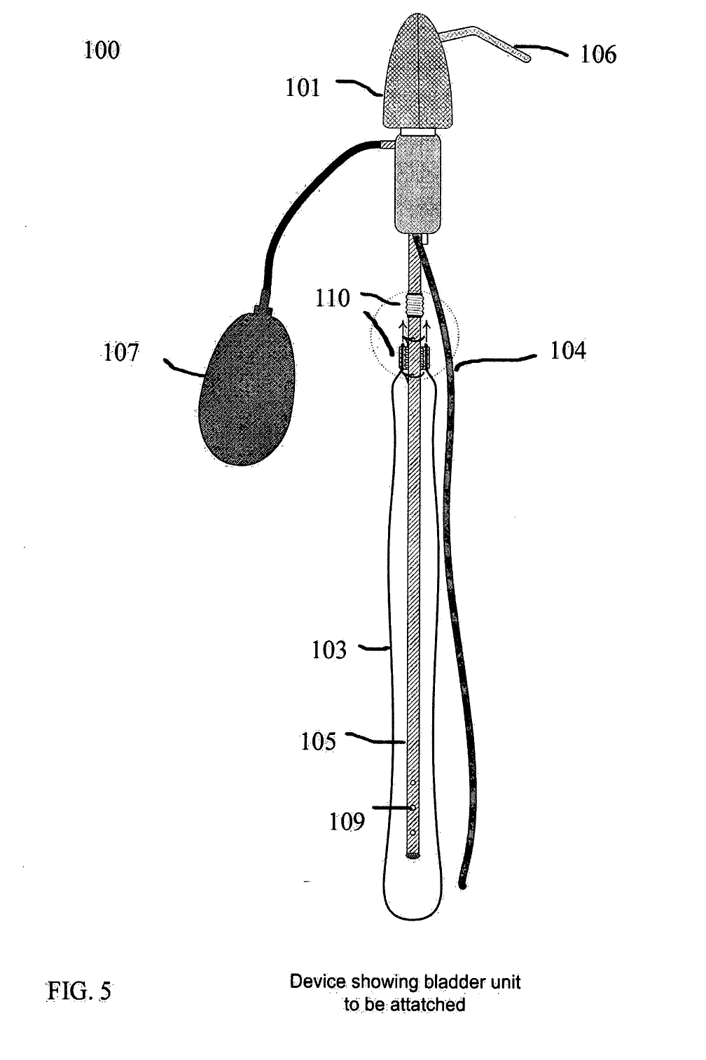

In another embodiment of the invention, a pump 107 can be provided operatively connected to the pressurization tube 102. See FIG. 5. The pump can function to pump gas and/or liquid through the pressurization tube 102 and into or out of the flexible bladder 103. It can be appreciated that the pump 107 can be provided to pump a measured amount of fluid and/or gas. For example, one embodiment of the invention can include a pump 107 which can provide a unit volume of fluid into the flexible bladder 103 whereby substantially the same amount of fluid in the container can be displaced and dispensed through the outlet pipe 106. It can be appreciated that one or more pumps 107 can be employed at different components in the system 100. For example, in another embodiment of the invention, a pump 107 can be provided operatively connected to the outlet pipe 106 for pumping gas and/or liquid into or out of the container.

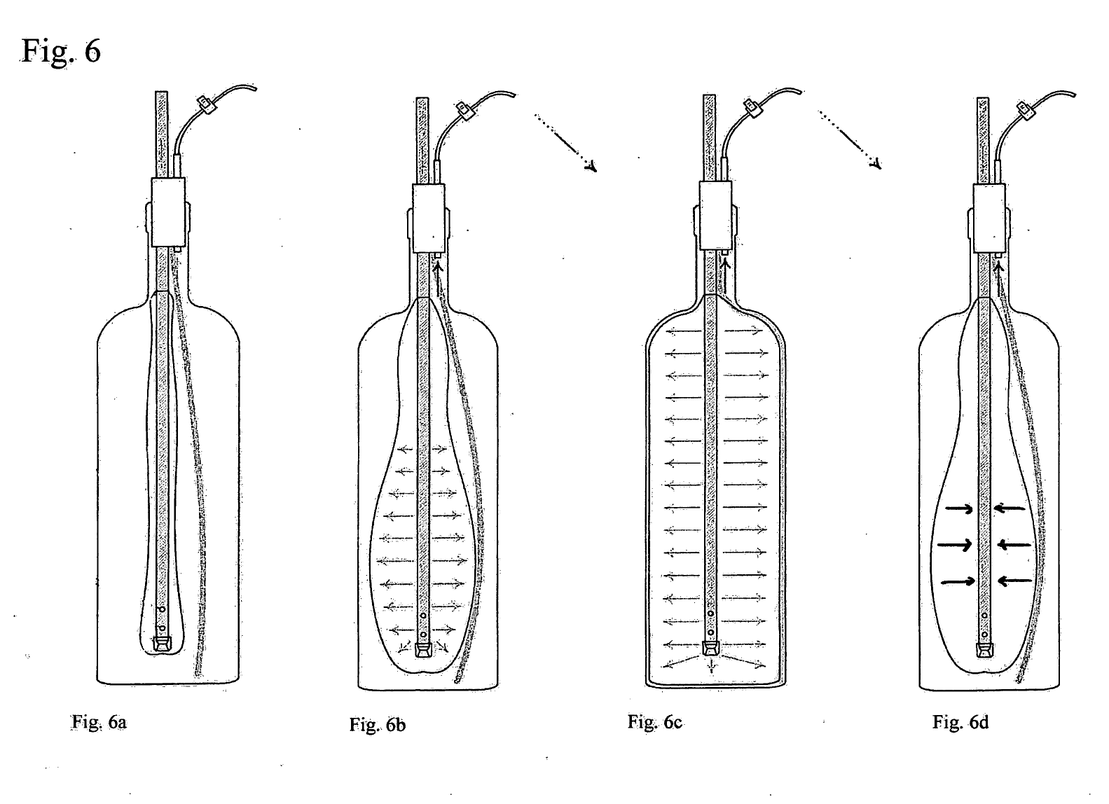

As shown in FIG. 6, a method of using a wine preservation system can comprise one or more steps. Preferably, a method includes providing a wine preservation system 100 having a container stopper 101, a pressurization tube 102, a flexible bladder 103, and an outlet pipe 106. In alternative methods according to the invention, the system 100 can also include one or more of a void former 104, a placement guide 105, an air pump 107, and a control valve 108.

As shown in FIG. 6a, a wine preservation system 100 is inserted into a container, and can be inserted using the placement guide for guiding the flexible bladder into the container. Once the container stopper is tightly positioned in a fluid/air-tight manner, gas remaining in the container can be removed by adding replacement fluid and/or gas into flexible bladder through the replacement tube, thereby expelling gas through the outlet pipe 106. Thereafter, additional replacement fluid and/or gas can be added to the flexible bladder through the replacement tube as shown in FIG. 6b, whereby additional contents of the container, such as wine, can be dispensed through the outlet pipe 106. As shown in FIG. 6c, this step can be repeated until substantially all fluid originally in the container is dispensed, and the volume within the container is replaced by the replacement fluid and/or gas provided in the flexible bladder.

As shown in FIG. 6d, the bladder 103 can be deflated and the system 100 can be removed from the container. In addition, or in the alternative, prior to the step of deflating the bladder 103, the outlet pipe 106 can be placed in a liquid, such as water or a washing solution, and upon deflation of the bladder, the liquid can fill the container. Such a step may be useful for rinsing or cleaning the container and portions of the system 100.

Alternatively, or in addition, a method according to the invention can include the steps of pumping fluid and/or gas into the container through the outlet pipe 106 and removing replacement fluid or gas in the flexible bladder. Alternatively, or in addition, a method according to the invention can include the step of removing and replacing the flexible bladder.

It can be appreciated that variations of the wine preservation and delivery system and method can be provided and adapted for various uses and are within the scope of the invention. For example, the wine preservation and delivery system 100 can be adapted for storage of fuel, or other gases or liquids. In addition, the wine preservation and delivery system 100 can be used for filling containers with liquid and/or gas, such as to prevent the liquid and/or gas from coming into contact with any air that might be in a container.

As shown in FIG. 7, the method can include using a void former to insert and/or withdraw wine from a container. By diverting fluid around an inflated or partially inflated flexible bladder, the method facilitates the flow of fluid into and out of the container.

Although preferred embodiments of the wine preservation and delivery system and method have been disclosed, a person of ordinary skill in the art can appreciate that other configurations of the wine preservation system and method are possible and within the scope of the invention.

I claim:

1. A wine preservation and delivery system comprising:
a container stopper, having a bottom side and a top side and being formed to fit within an aperture of a container;
a pressurization tube disposed through the container stopper, the pressurization tube having a first end and a second end;
a flexible bladder, the flexible bladder being disposed over at least a portion of the second end of the pressurization tube,
a outlet pipe, the outlet pipe disposed through the container stopper, and
a void former operatively connected to the container stopper.

2. A wine preservation and delivery system according to claim 1, wherein the void former comprises a tube having at least one aperture.

3. A wine preservation and delivery system according to claim 1, wherein the void former is disposed along a length of the flexible bladder.

4. A wine preservation and delivery system according to claim 1, wherein the void former is attached to the pressurization tube at at least one end of the void former.

5. A wine preservation and delivery system according to claim 1, wherein the void former comprises a plurality of tubes.

6. A wine preservation and delivery system according to claim 1, wherein the void former further comprises a plurality of ribs.

7. A wine preservation and delivery system according to claim 1, wherein the void former further comprises a plurality of rings.

8. A wine preservation and delivery system according to claim 1, wherein the void former further comprises a plurality of bumps.

9. A wine preservation and delivery system according to claim 2, wherein the void former further comprises a plurality of apertures, said plurality of apertures being disposed at least along a length of the void former.

10. A wine preservation and delivery system according to claim 2, wherein the void former further comprises a float and a weight.

11. A wine preservation and delivery system according to claim 1, wherein the pressurization tube further comprises a bladder protector disposed at the second end of the pressurization tube.

12. A wine preservation and delivery system according to claim 1, wherein the flexible bladder is connected to the pressurization tube at an air inlet region of the flexible bladder, and wherein the flexible bladder forms a substantially air-tight seal at a tube connection region of the pressurization tube.

13. A wine preservation and delivery system according to claim 1, wherein the flexible bladder is connected to the container stopper at an inlet region of the flexible bladder, and forms a substantially air-tight seal at the inlet region.

14. A wine preservation and delivery system according to claim 1, wherein the outlet pipe further comprises a flexible tube portion at a bottom end of the outlet pipe.

15. A wine preservation and delivery system according to claim 1, wherein the pressurization tube is rigid, whereby the flexible bladder can be guided through an aperture of a container and into the container.

16. A wine preservation and delivery system according to claim 1, wherein the pressurization tube is moveable within the container stopper and can be adjusted in length.

17. A wine preservation and delivery system according to claim 1, further comprising a pump connected to the pressurization tube.

18. A wine preservation and delivery system according to claim 1, further comprising a pump connected to the outlet pipe.

19. A wine preservation and delivery system according to claim 15, wherein the pump provides a measured amount of fluid into the flexible bladder.

20. A container contents isolation system comprising:
a container stopper, having a bottom side and a top side and being formed to fit within an aperture of a container;
a bladder access tube disposed through the container stopper, the bladder access tube having a first end and a second end;
a flexible bladder, the flexible bladder being disposed over at least a portion of the second end of the bladder access tube and being stretchable to conform to the inner surface of a container when inflated,
a container access tube pipe, the container access tube being disposed through the container stopper, and
a void former operatively connected to the container stopper.
